(19) United States
(12) Patent Application Publication
(10) Pub. No.: US 2008/0287049 A1
(43) Pub. Date: Nov. 20, 2008

(54) Cutting Disc

(76) Inventors: Beat Salzgeber, Visp (CH); Thomas Tschumi, Hessigkofen (CH); Daniel Jeiziner, Niklaus (CH); Roberto Mulone, Niklaus (CH)

Correspondence Address: MICHAEL J. STRIKER, 103 EAST NECK ROAD, HUNTINGTON, NY, 11743, US

(21) Appl. No.: 12/092,207

(22) PCT Filed: Oct. 27, 2006
(86) PCT No.: PCT/EP06/67843

§ 371 Date: Apr. 30, 2008

(30) Foreign Application Priority Data
Nov. 16, 2005 (DE) 10 2005 054 578.5

(51) Int. Cl. B23F 21/02

(52) U.S. Cl. 451/548

(57) ABSTRACT

The invention describes a cutting disc (100) comprising a circular-disc-shaped body (10) with a central hole (11) for accommodating a drive spindle, an annular cutting region (13), containing abrasive, at the circumference (12) of the circular-disc-shaped body (10) and a centred plastic damping element (20) with a central hole (21), wherein the damping element (20) is arranged on at least one first flat side (15) of the circular-disc-shaped body (10).

### RELATED ART

The present invention relates to a cutting disk, in particular a diamond cutting disk, according to the preamble of Claim 1.

The related art makes known diamond cutting disks used to cut through masonry, stone, concrete, and similar materials, which are composed of a disk-shaped body made of metal, and an annular cutting region on the circumference of the body. The annular cutting region is designed, e.g., in the shape of cutting segments and is composed of a metal matrix that contains diamond particles. The cutting segments are connected with the circular disk-shaped body, e.g., via laser welding or sintering.

Publication DE 201 02 684 U makes known a grinding disk with a metallic support body and a grinding ring, preferably a grinding ring that contains a cubic boron nitride or diamond. A vibration-damping intermediate ring composed of impregnated, high-strength fibers, e.g., carbon fibers, is provided between the support body and the grinding ring; it is designed as a separate part and is bonded with the support body and/or the grinding ring.

The disadvantage of the grinding disk made known in DE 201 02 684 U is its complicated manufacture, since the vibration-damping intermediate ring must be bonded with the support body and the grinding ring in a stable manner. In addition, due to the intermediate ring, the hardness of the grinding disk is insufficient.

The object of the present invention is to provide a vibration-damping cutting disk that is relatively easy to manufacture.

### DISCLOSURE OF THE INVENTION

The object of the present invention is a cutting disk with the features stated in Claim 1.

The inventive cutting disk has the advantage that it is relatively easy to manufacture and is relatively stable, since the damping element is centrally located on at least one flat side of the circular disk-shaped body.

The inventive cutting disk includes a circular disk-shaped body with a central hole for accommodating a drive spindle. The circular disk-shaped body is also referred to below as the blade body. The blade body is made of metal, in particular steel, and has a diameter, e.g., in the range of 100 to 600 mm, and a thickness in the range of 1 to 5 mm. An annular cutting region that includes grinding means is provided on the circumference of the circular disk-shaped body. The annular cutting region is undetachably secured to the circumference of the blade body, e.g., via sintering, laser welding, laser melting, or brazing.

It is a diamond cutting disk, in particular, with which the blade body is composed of metal, in particular of steel, and the cutting region contains diamonds as the grinding means. The diamonds are embedded in a metallic carrier material, which is known from the related art, and which is shaped via sintering or casting (laser melting). Hard grinding means other than diamond may also be used, e.g., cubic boron nitride.

It is also a segmented cutting disk in particular, and particularly preferably a segmented diamond cutting disk, i.e., the annular cutting region is segmented. Segmented cutting disks are basically known from the related art. The segments may be selected in accordance with the application of the cutting disk—which is preferably segmented—e.g., in terms of their length and number. The inventive cutting disk may also be a non-segmented cutting disk with a closed cutting region, however.

According to the present invention, a damping element is centrally located on at least a first flat side of the blade body, so that the central hole of the damping element and the central hole of the blade body are located one over the other in order to accommodate the drive spindle. When the cutting disk is installed in a machine tool, the damping element is located, in particular, on the flat side of the blade body facing away from the machine tool. It is also possible to provide the damping element on the other flat side of the blade body, which faces the machine tool. It is also possible to provide a centrally located damping element on both of the flat sides of the blade body.

The damping element is rotationally symmetrical in particular, and is preferably designed in the shape of a circular disk. It may also be, e.g., square, or it may have an irregular flat shape, provided the damping element does not cause imbalance in the rotating cutting disk due to its shape.

The damping element has a thickness in the range of 0.1 to 10 mm, in particular, and preferably from 2 to 5 mm, e.g., 3 mm. The diameter of the damping element is selected such that the cutting depth is not affected. For example, a cutting disk with a diameter in the range of 115 to 150 mm has a damping element with a diameter in the range of 50 to 55 mm, e.g., 53 mm, and a cutting disk with a diameter in the range of 180 to 230 mm has a damping element with a diameter in the range of 70 to 90 mm, e.g., 80 mm.

The damping element is made of plastic, in particular at least one thermoplastic plastic. The damping element may be composed of a mixture of plastics, e.g., a mixture of thermoplastic plastics, which may be reinforced or not. It may also contain several layers of various plastics. To increase the damping effect, the damping element may contain two layers, for example. A first layer, which faces the first flat side of the blade body and therefore rests on the blade body, is composed of an elastomer, and a second layer is composed of a thermoplastic plastic. If the damping element is composed of thermoplastic plastic, it may be manufactured easily via injection-molding.

Advantageously, the damping element is detachably connected with the circular disk-shaped body. In an embodiment of the inventive cutting disk, the damping element rests on a first flat side of the blade body. When the cutting disk is clamped to a drive spindle of a machine tool, the cutting disk with the damping element is clamped, e.g., axially between two clamping flanges, e.g., a locknut and a mating flange.

In a further embodiment, the damping element is detachably connected with the cutting disk in that the damping element includes at least one connecting element, and the circular disk-shaped body includes at least a first opening for accommodating the connecting element. The connecting element is a projecting region on the surface of the damping element that faces the first flat side of the circular disk-shaped body. A first opening—which is shaped accordingly—in the blade body accommodates the connecting element in a form-fit manner. The connecting element engages in a first opening of the blade body, in an overlatching manner in particular. It abuts the second flat side of the circular disk-shaped body, preferably in an essentially flush manner. This means the connecting element engages in the first opening of the cutting disk so far that it abuts the back side, i.e., the flat side that faces away, in a largely flush manner. The thickness of the connecting element is therefore preferably the same as the thickness of the blade body. The connecting element serves to prevent the damping element from rotating relative to the cutting disk when the cutting disk rotates on or is clamped to a working spindle. Instead of abutting the back side of the blade body in a flush manner, the connecting element may engage in a first opening of the blade body to a lesser extent by designing the connecting element to be thinner than the blade body.

The connecting element—in addition to the damping element—is also made of plastic, and it is designed in particular as a single piece with the damping element. Any shape may be chosen for the connecting element and the corresponding first opening, e.g., rectangular, oval, or kidney-shaped. In addition, the connecting element may be positioned at any point on the surface of the damping element, and it may be oriented in any direction, e.g., in the radial direction.

In a further embodiment, the damping element includes—in addition or as an alternative—preferably at least one snap-in element, and the circular disk-shaped body includes at least a second opening for accommodating the snap-in element in a form-fit manner, in order to detachably connect the cutting disk. The snap-in element is also made of plastic, and it is designed in particular as a single piece with the damping element. When the damping element is installed with at least one snap-in element, the snap-in element passes through a related second opening in the blade body and engages in the second opening. When the snap-in element is engaged in a second opening, it extends—particularly preferably—beyond the second flat side of the circular disk-shaped body. This means the snap-in element engages in the second opening of the cutting disk so far that it extends beyond the back side—i.e., beyond the flat side that faces away—of the blade body. The at least one snap-in element serves to secure the damping element axially, thereby enabling the damping element to be attached to the cutting disk in the correct position.

In a preferred embodiment of the inventive cutting disk, two diametrically-opposed snap-in elements are provided, each of which is accommodated in a second opening in the circular disk-shaped body. The two snap-in elements are located, e.g., in the edge region of the blade body. The diametral location of two snap-in elements results in a particular good axial fastening of the damping element on the cutting disk.

The damping element also preferably includes at least one opening, which serves as the viewing window. The opening in the damping element may have any shape. Information may be engraved in the region of the opening, e.g., information in the form of characters, in particular numbers and letters, e.g., the diameter and thickness or the maximum rotational speed of the cutting disk. This information on the cutting disk may be read easily through the opening, and it is protected against wear by the damping element.

Preferably, the damping element also includes spacers on the surface facing the first flat side of the circular disk-shaped body. The spacers form projecting regions on the surface of the damping element that faces the first flat side of the circular disk-shaped body. The spacers rest on the first flat side of the blade body. The damping element with spacers therefore does not rest on the blade body with its entire surface, but only with the surfaces of the spacers. This reduces the contact surface between the damping element and the cutting disk, and it increases the heat-dissipating effect of the damping element.

The spacers—in addition to the damping element—are also made of plastic, and they are designed in particular as single pieces with the damping element. They may have any shape, in principle, although they preferably have the shape of radially located ribs, which are preferably curved in the direction of rotation of the cutting disk. The ribs extend, e.g., 1 to 5 mm away from the surface of the damping element. The regions between the ribs form cavities between the damping element and the cutting disk. The spacers—in the form of radially located ribs—serve as fan blades and thereby support the cooling effect of the damping element.

The inventive cutting disk may be used in various machine tools, e.g., in angle grinders, hand-guided disk sanders, wall chasers, slot cutters, gasoline-power saws, bench saws, crevice cutters, and hand-held cut-off saws.

It is suitable for use with various materials, such as concrete, natural stone, asphalt, ceramic, and other construction materials.

It is suited for use for dry cutting or wet cutting.

The present invention is explained below in greater detail below with reference to the attached drawing.

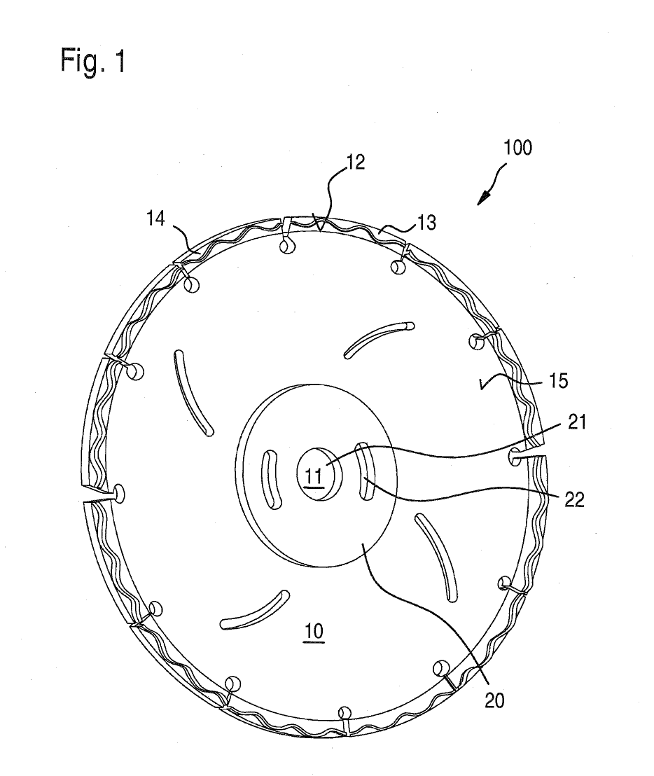

FIG. 1 shows an embodiment of an inventive cutting disk with a damping element in a perspective view of a first flat side of the blade body,

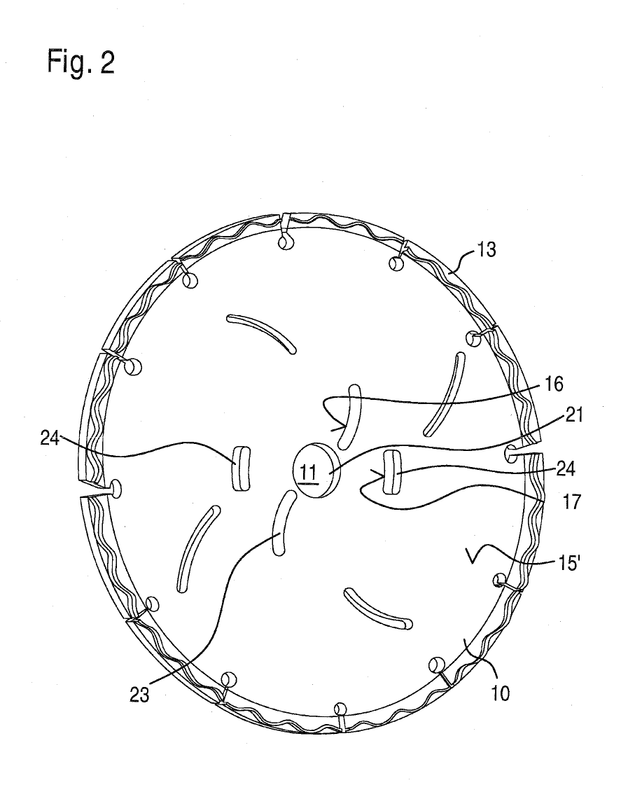

FIG. 2 shows the cutting disk in FIG. 1 in a perspective view of the second flat side of the blade body, and

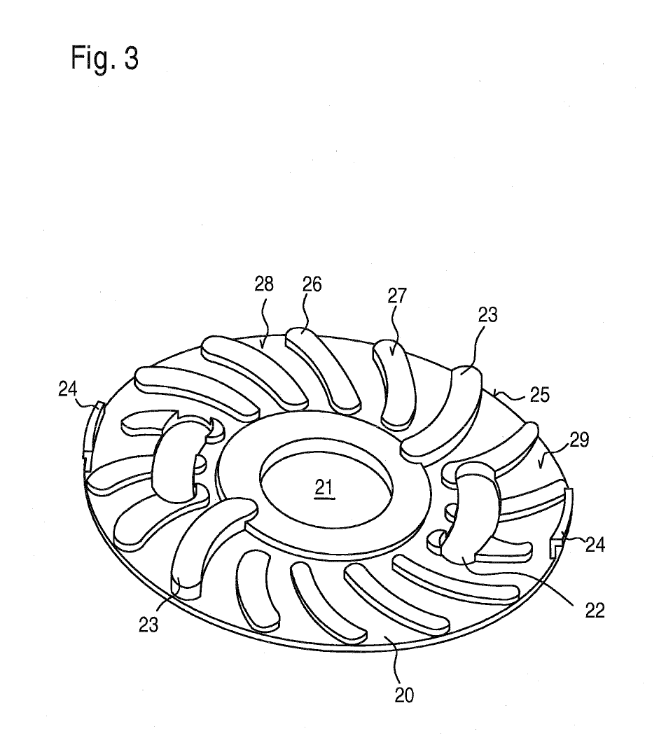

FIG. 3 shows an embodiment of a damping element from the underside, i.e., from the side facing the first flat side of the blade body.

A cutting disk 100 is shown in a perspective view in FIG. 1. Cutting disk 100 has a circular disk-shaped body (also referred to as a blade body) 10 with a central hole 11 for accommodating a drive spindle (not shown), and a first flat side 15 and a second flat side 15′ (FIG. 2) on the back side. An annular cutting region 13 that includes grinding means is provided on circumference 12 of circular disk-shaped body 10. The cutting disk shown is a segmented cutting disk 100, with which cutting region 13 is subdivided into segments 14. A circular disk-shaped damping element 20 made of plastic is centrally located on first flat side 15. A central hole 21 of damping element 20 is aligned with central hole 11 in blade body 10. In the installed state, e.g., in an angle grinder (not shown), a mating flange is seated non-rotatably on the drive spindle, and supports second flat side 15′ of blade body 10 to drive it rotationally. A screwable locknut also bears against damping element 20. Damping element 20 also has two openings 22, which serve as viewing windows, and which are oval and curved in the embodiment shown.

The back side and/or underside of a damping element 20 shown in FIG. 3 shows surface 29 of damping element 20, which is placed on first flat side 15 of circular disk-shaped body 10. Damping element 20 has two connecting elements 23, which are oval and curved in the embodiment shown, and they are oriented nearly radially. Connecting elements 23 engage in a first opening 16 (FIG. 2) in blade body 10 and abut second flat side 15′ of blade body 10 in an essentially flush manner. In addition, two snap-in elements 24 are diametrically located on the edge, i.e., in the region of circumference 25 of damping element 20. Snap-in elements 24 engage in a second opening 17 of blade body 10 and extend past second flat side 15′ of blade body 10. The two diametrically located snap-in elements 24 result in good axial securing of damping element 20. Connecting elements 23 prevent damping element 20 from rotating and therefore reduce the load on snap-in elements 24 caused by shearing. In addition, spacers 26—designed as ribs—are provided on damping element 20. Spacers 26 are oval and curved in the embodiment shown, and they are oriented nearly radially. Spacers 26 are distributed essentially evenly across the surface of damping element 20. Damping element 20 bears with surface 27 of spacers 26 against first flat side 15 of blade body 10. Channels 28 are formed between spacers 26. When damping element 20 is placed on blade body 10, channels 28 interact with blade body 10 to form cavities. Spacers 26 designed as curved ribs serve as fan blades in that air in channels 28 flows in the direction of the blade body due to centrifugal force. Suction results, which draws air over openings 22. In addition to its damping effect, damping element 20 therefore also has a cooling effect.

What is claimed is:

1. A cutting disk, including a circular disk-shaped body (10) with a central hole (11) for accommodating a drive spindle, an annular cutting region (13) with grinding means, located on the circumference (12) of the circular disk-shaped body (10), and a centrally located damping element (20) made of plastic, with a central hole (21),
wherein
the damping element (20) is located on at least a first flat side (15) of the circular disk-shaped body (10).

2. The cutting disk as recited in claim 1,
wherein
the damping element (20) has the shape of a circular disk.

3. The cutting disk as recited in claim 1,
wherein,
the damping element (20) contains at least one thermoplastic plastic.

4. The cutting disk as recited in claim 1,
wherein
the damping element (20) is detachably connected with the circular disk-shaped body (10).

5. The cutting disk as recited in claim 1,
wherein
the damping element (20) includes at least one connecting element (23), and the circular disk-shaped body (10) contains at least a first opening (16) for accommodating the connecting element (23).

6. The cutting disk as recited in claim 5,
wherein
the connecting element (23) abuts a second flat side (15′) of the circular disk-shaped body (10) in an essentially flush manner.

7. The cutting disk as recited in claim 1,
wherein
the damping element (20) includes at least one snap-in element (24), and the circular disk-shaped body (20) includes at least a second opening (17) for accommodating the snap-in element (24).

8. The cutting disk as recited in claim 7,
wherein
the snap-in element (24) extends over a second flat side (15′) of the circular disk-shaped body (10).

9. The cutting disk as recited in claim 7,
wherein
two snap-in elements (24) are provided, which are diametrically opposed to each other.

10. The cutting disk as recited in claim 1,
wherein
the damping element (20) includes at least one opening (22), which serves as a viewing window.

11. The cutting disk as recited in claim 1,
wherein
the damping element (20) includes spacers (26) on the side (29) facing the first flat side (15) of the circular disk-shaped body (10).

12. The cutting disk as recited in claim 11,
wherein
the spacers (26) are radially located ribs.

13. The cutting disk as recited in claim 12,
wherein
the radially located ribs are curved.
